(19) United States
(12) Patent Application Publication
(10) Pub. No.: US 2016/0335294 A1
(43) Pub. Date: Nov. 17, 2016

(54) System and Method for Organizing Data

(71) Applicant: Bjorn J. Gruenwald, Newtown, PA (US)

(72) Inventor: Bjorn J. Gruenwald, Newtown, PA (US)

(21) Appl. No.: 15/155,051

(22) Filed: May 15, 2016

Related U.S. Application Data
(60) Provisional application No. 62/162,628, filed on May 15, 2015.

(51) Int. Cl. G06F 17/30

(52) U.S. Cl. CPC G06F 17/30312; G06F 17/30424

(57) ABSTRACT

Various implementations of the invention treat a character string comprising a plurality of ASCII characters collectively as a single integer. In other words, various implementations of the invention simply treat the plurality of ASCII characters in the character string as an integer data type (e.g., integer, long integer, double integer, bigint, word, double word, quadword, etc.) based in part on the number of characters in the ASCII string and a number of bits of registers and/or data buses of a relevant computing processor. For example, processors with 64-bit registers and data buses can accommodate 8 ASCII characters (each ASCII character comprises 8 bits) in their registers as a typical integer, 16 ASCII characters as a typical double integer, etc.; processors with 128-bit registers and data buses can accommodate 16 ASCII characters in their registers as a typical integer, 32 ASCII characters as a typical double integer, etc. Once character strings of multiple ASCII characters are treated as single integers, processing of such integers becomes highly efficient relative to processing of their corresponding character strings.

### CROSS-REFERENCE TO RELATED APPLICATIONS

This Application claims priority to U.S. Provisional Application No. 62/162,628, which was filed on May 15, 2015, and entitled “System and Method for Organizing Data.” The foregoing application is incorporated herein by reference in its entirety.

### FIELD OF THE INVENTION

The invention is generally related to organizing and managing data in a database, and more particularly, to treating character strings comprising a plurality of ASCII characters as a numerical value to improve processing efficiency.

### BACKGROUND OF THE INVENTION

Computerized database systems have long been used and their basic concepts are well known. In general, database systems are designed to organize, store and retrieve content in such a way that the content in the database is useful. For example, the content is typically represented as data that may be searched, sorted, organized and/or combined with other data. To a large extent, the usefulness of a particular database system is dependent on an ability to efficiently access the data (and hence the content represented by the data) in the database system.

One drawback of many conventional database systems is that much of the content in such database systems is represented by data in the form of character strings (e.g., ASCII, etc.). Character strings are inherently inefficient. As is generally known, a character string comprises a number of individual characters organized as a string data structure or an array data structure. Processing of the character string, at least at a processor level, is on a character-by-character basis. In other words, if the processing of character strings includes comparing one character string to another character string, such comparing is done character-by-character until a difference is identified or until an end of string is identified. If all the characters in the two character strings are the same and the two character strings have a same length, the two character strings are deemed the same.

In addition to the inefficiencies associated with processing content stored as data in the form of character strings, databases themselves have become extremely large and unwieldy, many comprising thousands or tens of thousands of terabytes of data. Processing such data in a conventional manner consumes an inordinate amount of time, making many tasks virtually impossible to accomplish.

What is needed is a system and method for organizing data in a database system to overcome these and other associated problems.

### SUMMARY OF THE INVENTION

Various implementations of the invention organize data in a database. In some implementations of the invention, the database or data table is split into a plurality of original field files, wherein the data table comprises of a plurality of rows and a plurality of columns, wherein each of the plurality of rows comprises a data record of the data table, wherein each of the plurality of columns comprises a data field of the data table, wherein each of the plurality of original field files comprises a column split from of the plurality of columns, wherein each of the plurality of original field files comprises a number of data values (i.e., data entries) corresponding to a number of the plurality of rows. In some implementations of the invention, a sort order for the data values in a corresponding one of the plurality of original field files is determined and an array of sorted indices for the corresponding one of the plurality of original field files is generated by sorting an array of indices based on the sort order, wherein each index in the array of indices points to a data value in the corresponding one of the plurality of original field files. In some implementations of the invention, an array of sorted indices is generated for each of the plurality of original field files. In some implementations of the invention, each original field file and its corresponding array of sorted indices are stored together and subsequently used to process content of the data table.

In some implementations of the invention, a binary search for a search term may be conducted against any one or all of the plurality of original field files using the associated array of sorted indices to determine which index points to a data value in the one of the plurality of original field files that matches the search term.

In some implementations of the invention, once the index is determined, the index may be used to retrieve data related to the search term across one or all of the plurality of original field files. In such implementations, such retrieved data corresponds to a row of data table. In some implementations of the invention, the index may be used to retrieve an actual data record from the data table (or database) as would be appreciated.

In some implementations of the inventions, one or more of the original field files comprises a plurality of character strings, where each character string comprises a plurality of characters. In these implementations of the invention, such plurality of characters in each character string are collectively treated as a single integer value (as opposed to a number of individual characters). In other words, these character strings are read, written, compared, or otherwise processed as a single integer value.

These and other implementations of the invention are described in further detail below in connection with the accompanying drawings.

### BRIEF DESCRIPTION OF THE DRAWINGS

FIG. 1 illustrates an example data processing system in accordance with various implementations of the invention.

FIG. 2 illustrates an example data record in accordance with various implementations of the invention.

FIG. 3 illustrates an example of a character string in a data field in accordance with various implementations of the invention.

FIG. 4 illustrates an example database in accordance with various implementations of the invention.

FIG. 5 illustrates a plurality of original field files in accordance with various implementations of the invention.

FIG. 6 illustrates an original field file and implied row numbers for such original field file in accordance with various implementations of the invention.

FIG. 7 illustrates original field file as it may be stored in a block of memory in accordance with various implementations of the invention that use character strings of fixed length.

FIG. 8 illustrates sorted row numbers and corresponding data from original field file to which such row numbers point in accordance with various implementations of the invention.

FIG. 9 illustrates an original field file and implied addresses for such original field file in accordance with various other implementations of the invention.

FIG. 10 illustrates an original field file as it may be stored in a block of memory in accordance with various implementations of the invention that use a character count to separate character strings.

FIG. 11 illustrates an original field file as it may be stored in a block memory in accordance with various implementations of the invention that use a null character to separate character strings.

FIG. 12 illustrates sorted addresses, implied row numbers for such sorted addresses, and corresponding data from original field file to which such sorted addresses point in accordance with various implementations of the invention.

FIG. 13 illustrates an original field file and stored addresses for each of the corresponding data in original field file in accordance with various implementations of the invention that contiguously store character strings.

FIG. 14 illustrates an original field file as it may be stored in a block of memory in accordance with various implementations of the invention that contiguously store character strings.

FIG. 15 illustrates sorted addresses, implied row numbers for such sorted addresses, and corresponding data from original field file to which such sorted addresses point in accordance with various implementations of the invention.

FIG. 16 illustrates an operation of various implementations of the invention.

### DETAILED DESCRIPTION

Various implementations of the invention are directed towards systems and methods for organizing data in a database system. Various implementations of the invention are described below with respect to various database applications, where large amounts of content in the form of data is compiled, stored, manipulated, and/or analyzed to determine various relationships present in the content.

In some implementations of the invention, a database system is used to store content in the form of data records that include data associated with accounts receivable. In such implementations, a company may collect content, in the form of data, relating to various persons, businesses and/or accounts from one or more sources. The sources may include, for example, credit card companies, financial institutions, banks, retail, and wholesale businesses and other such sources. While each of these sources may provide data relating to various accounts, each source may provide data representing different information based on its own needs. Furthermore, this data may be organized in entirely different ways. For example, a wholesale distributor may have data corresponding to accounts receivable corresponding to business accounts. Such data may be organized by account numbers, with each data record having data fields identifying an account number, a business name associated with that account number, an address of that business, and an amount owed on the account. A retail company may have data records representing similar information but based on accounts corresponding to individuals as well as businesses.

Various implementations of the invention may use data, including different types of data, from a wide variety of sources. For example, the scientific institutions may provide scientific data with respect to various areas of research. Industrial companies may provide industrial data with respect to raw materials, manufacturing, production, and/or supply. Courts or other types of legal institutions may provide legal data with respect to legal status, judgments, bankruptcy, and/or liens. Social media companies may provide business intelligence based on user interaction. Security companies or government entities may provide security intelligence based on accessed or monitored communications.

U.S. Pat. No. 6,424,969 to Bjorn Gruenwald, entitled “System and Method for Organizing Data” (the “969 Patent”), the entirety of which is incorporated herein by reference, describes a system that converts a character string (e.g., ASCII character string) to a numerical value in a number system, where the number system has a radix at least equal to a number of different symbols (e.g., characters) in the character string. For typical character strings that are restricted to the characters ‘0’-‘9’ and ‘A’-‘Z’ (referred to as “alphanumeric characters”), a base-40 number system was utilized. In the '969 Patent, each of the alphanumeric characters was assigned a numeric value, represented as either a hexadecimal value or decimal value in accordance with Table 1:

TABLE I

| Character | Hexadecimal | Decimal |
|---|---|---|
| 0 | 00 | 0 |
| 1 | 01 | 1 |
| 2 | 02 | 2 |
| 3 | 03 | 3 |
| 4 | 04 | 4 |
| 5 | 05 | 5 |
| 6 | 06 | 6 |
| 7 | 07 | 7 |
| 8 | 08 | 8 |
| 9 | 09 | 9 |
| A or a | 0A | 10 |
| B or b | 0B | 11 |
| C or c | 0C | 12 |
| D or d | 0D | 13 |
| E or e | 0E | 14 |
| F or f | 0F | 15 |
| G or g | 10 | 16 |
| H or h | 11 | 17 |
| I or i | 12 | 18 |
| J or j | 13 | 19 |
| K or k | 14 | 20 |
| L or l | 15 | 21 |
| M or m | 16 | 22 |
| N or n | 17 | 23 |
| O or o | 18 | 24 |
| P or p | 19 | 25 |
| Q or q | 1A | 26 |
| R or r | 1B | 27 |
| S or s | 1C | 28 |
| T or t | 1D | 29 |
| U or u | 1E | 30 |
| V or v | 1F | 31 |
| W or w | 20 | 32 |
| X or x | 21 | 33 |
| Y or y | 22 | 34 |
| Z or z | 23 | 35 |
| [ | 24 | 36 |
| \ | 25 | 37 |
| ] | 26 | 38 |
| \hat{ } | 27 | 39 |

Using Table I and using appropriately assigned symbols (or digits as described in the '969 Patent) to the numbers in base-40, the character string “JOHN”, which is comprised of four alphanumeric characters “J” “O” “H” and “N” would be represented in a base-40 number system as the base-40 number ‘JOHN’ having a decimal value equivalent of 1,255,103 (i.e., 19*40³+24*40²+17*40¹+23*40⁰, where alphanumeric character “J” has a decimal value of 19, alphanumeric character “O” has a decimal value of 24, alphanumeric character “H” has a decimal value of 17, and alphanumeric character “N” has a decimal value of 23).

Rather than converting a character string to a numeric value in a particular number system, various implementations of the invention simply treat the character string as an integer data type (e.g., integer, long integer, double integer, bigint, word, double word, quadword, or other integer data type) based in part on the number of characters in the character string. For example, in ASCII, each character comprises 8 bits. Processors with 64-bit registers and data buses can accommodate 8 ASCII characters in their registers as a typical integer, 16 ASCII characters as a typical double integer, etc.; processors with 128-bit registers and data buses can accommodate 16 ASCII characters in their registers as a typical integer, 32 ASCII characters as a typical double integer, etc. Hence, rather than treating, for example, a character string “New York” as eight (8) ASCII characters each eight (8) bits wide and processing this string on a character-by-character basis, the entire character string may be treated as a single 64-bit integer (by whatever such an integer data type is referenced in the corresponding programming language) according to various implementations of the invention. Depending on how the character string is stored in memory, the eight bytes comprising the character string may be read as a single 64-bit integer straight out of memory; or the eight bytes comprising the character string may be read consecutively byte-by-byte (or other unit less than the full 64-bit integer) out of memory; or individual eight bits may be added to a data register (or loaded into the data register for the first eight bits), followed by an eight bit shift left of the register (or the equivalent) to accommodate each additional character in the character string as would be appreciated. Other mechanisms may also be used to load the eight characters into the 64-bit integer as would be appreciated. Loading the entire character string “New York” as a single integer results in such an integer having a hexadecimal value of 4E657720596F726B. In this manner, the character string “New York” may be treated as a single numeric value and processed accordingly. These implementations of the invention do not require any selection of a number system or conversion of the character string into such number system.

One benefit of various implementations of the invention is that the character string “New York”, once treated as a single integer (or numeric value as discussed in the '969 Patent), may be compared in a single instruction cycle to other character strings for purposes of determining equivalency with such character strings rather than eight byte-wise comparisons as typically required by conventional character string comparisons. Other benefits also exist as would be appreciated. Once the character string is treated as a single integer, the processing of the integer may be conducted in accordance with the principles described in the '969 Patent.

Various implementations of the invention apply as discussed above, regardless as to the mechanism by which a given processor stores character strings or integers in memory. For example, various implementations of the invention apply regardless of whether data is stored following a “big endian” or “little endian” protocol—in either case, each unique character string will also have a unique integer value.

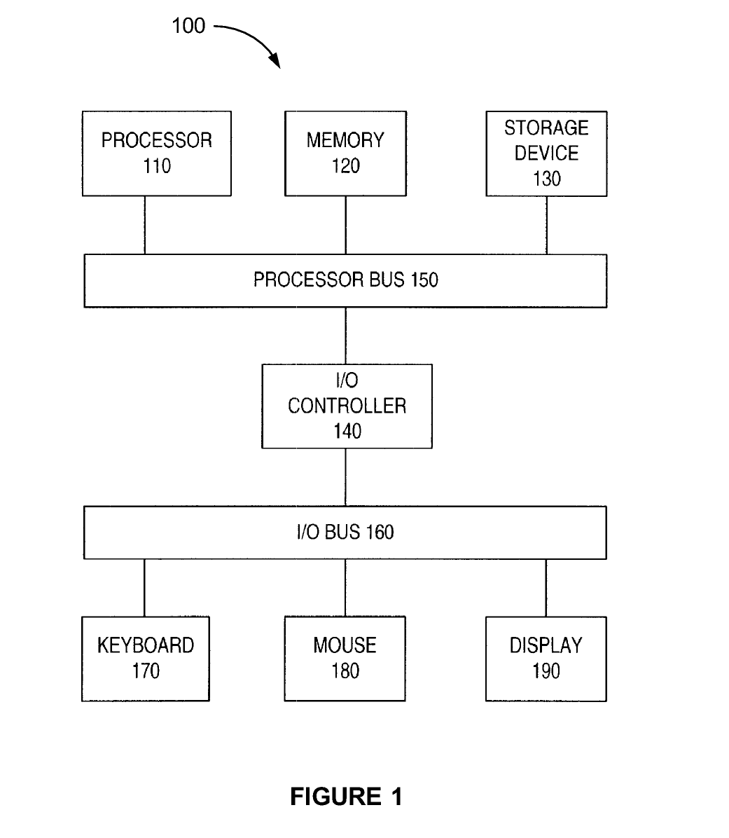

FIG. 1 illustrates an example data processing system 100 in accordance with various implementations of the invention. In general, various implementations of the invention may comprise hardware or software, or a combination of both. Some implementations of the invention comprise a software program executing on programmable data processing system 100. In some implementations of the invention, data processing system 100 comprises a processor 110, a memory 120, a data storage device 130 (e.g., disk, etc.), and an I/O controller 140—all of which may be coupled to one another by a processor bus or data bus 150. In some implementations of the invention, I/O controller 140 is also coupled via an I/O bus 160 to various input and output devices, such as a keyboard 170, a mouse 180, a display 190, and/or other output devices. Other components may be included in the system 100 as would be apparent.

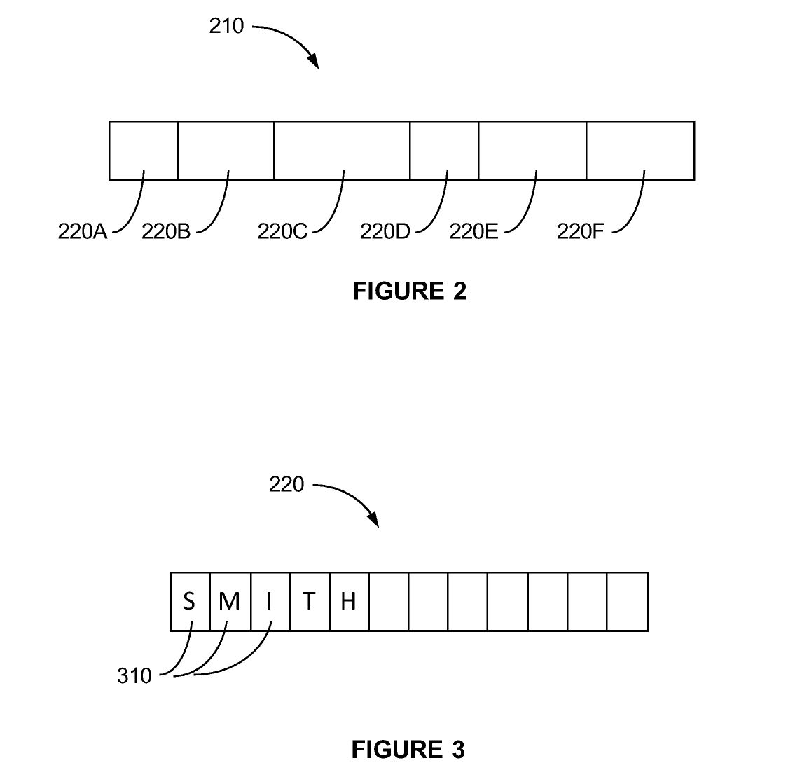

FIG. 2 illustrates an example of a data record 210 in accordance with various implementations of the invention. As would be appreciated, each data record 210 generally includes related information, such as information for a specific individual, company, account, or other aggregation of related data. Each data record 210 stores this information as data values in one or more data fields 220 (illustrated in FIG. 2 as a data field 220A, a data field 220B, a data field 220C, a data field 220D, a data field 220E, and a data field 220F). Examples of possible data fields 220 include, for example, an account number, a last name, a first name, a company name, an account balance, an address, a phone number, or other data fields as would be appreciated.

FIG. 3 illustrates an example of a character string in data field 220 in accordance with various implementations of the invention. Each data field 220 may include one or more data elements 310 for representing the character string in that data field in its corresponding data record. Data elements 310 may exist in various formats, such as alphanumeric, numeric, or other formats, as would be appreciated. According to various implementations of the invention, data elements 310 in data field 220 may be collectively referred to as a character string as would be appreciated.

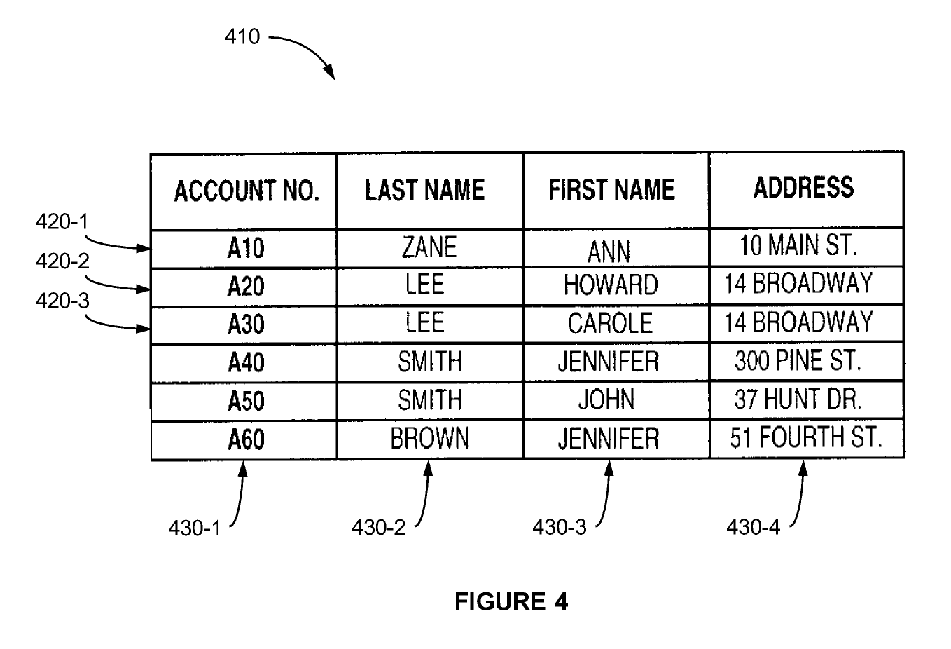

FIG. 4 illustrates an example of a database 410 in accordance with various implementations of the invention. As would be appreciated, database 410 may be referred to as a data table 410. Data table 410 may comprise a plurality of data records 420 (illustrated, for example, as a data record 420-1, a data record 420-2, a data record 420-3, etc.), where each data record 420 corresponds to a row in data table 410 as would be appreciated. Each data record 420 may comprise a plurality of data fields 430 (illustrated, for example, as a data field 430-1, a data field 430-2, a data field 430-3, a data field 430-4, etc.), where the same data field 430 across all data records 420 collectively correspond to a column in a data table 410 as would be appreciated.

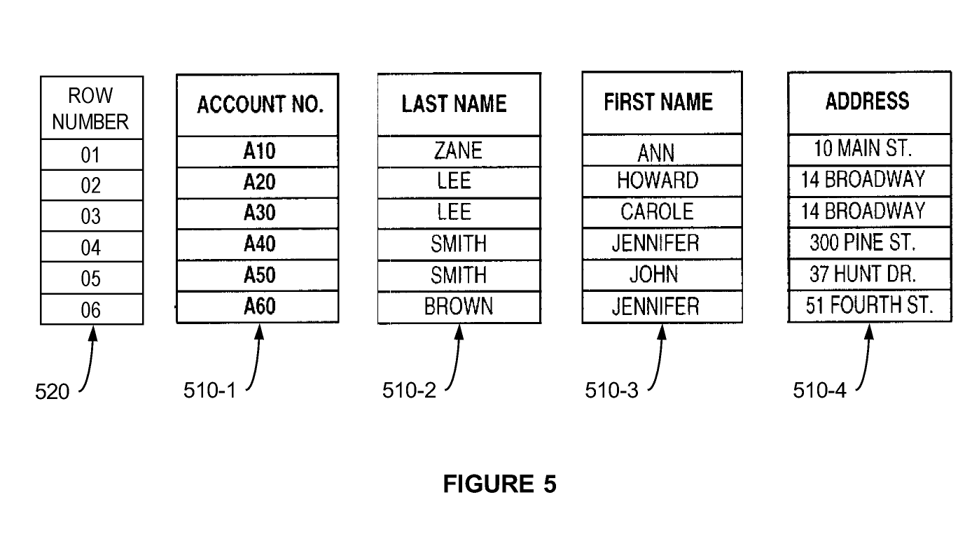

FIG. 5 illustrates an example of a plurality of original field files 510 (illustrated as an original field file 510-1, an original field file 510-2, an original field file 510-3, and an original field file 510-4) that are split out from data table 410 in accordance with various implementations of the invention. As illustrated, each original field file 510 corresponds to a data field 430, or column, of data table 410. According to various implementations of the invention, original field file 510 becomes the basic unit on which the invention operates to achieve various processing efficiencies. FIG. 5 also illustrates a row number file 520, which corresponds to a row number for each individual data value in each original field file 510. This row number may also be considered as, and referred to, an index into original field file 510 as would be appreciated. Row number file 520 may be an actual file or the row numbers may be implied.

In some implementations of the invention, each original field file 510 may be stored in memory or on a storage device with a row file 520 as a 2-by-n array (where n is the number of records in data table 410). In some implementations of the invention, each original field file 510 may be stored in memory or on a storage device with a row file 520 as two 1-by-n arrays. In some implementations of the invention, each original field file 510 may be stored in memory or on a storage device as a 1-by-n array; in such implementations, the row number or index is referred to herein as an implied row number or implied index simply based on a position of each individual data value in original field file 510. As would be appreciated, an implied row number or implied index is associated with each of the data values that correspond to a given data record 420 of data table 410 across all data fields 430.

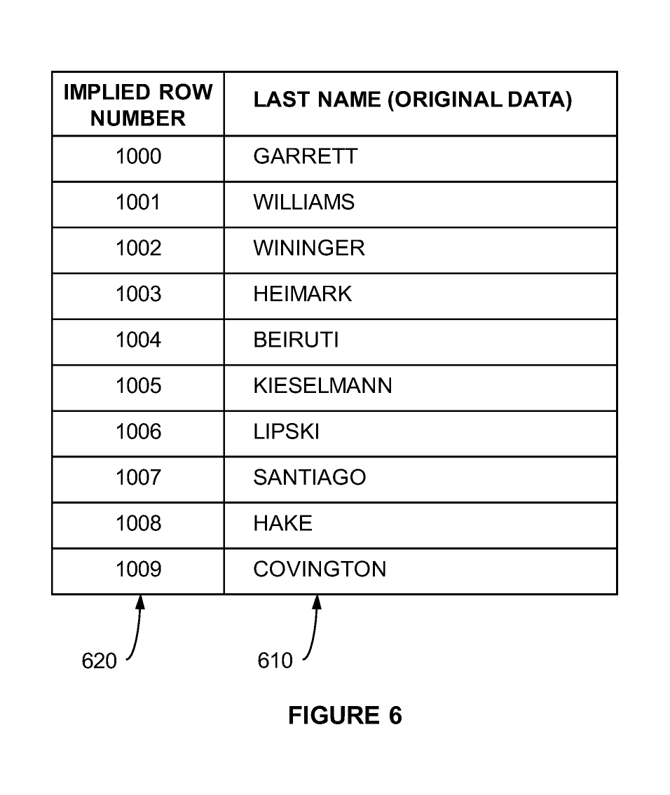

FIG. 6 illustrates an original field file 610 and its implied row numbers 620 in accordance with various implementations of the invention. As illustrated, original field file 610 corresponds to a last name field represented as an ASCII character string having a fixed length. The implied row numbers correspond to a position (e.g., a row or data record) where that data value appears in the relevant data table (not otherwise illustrated).

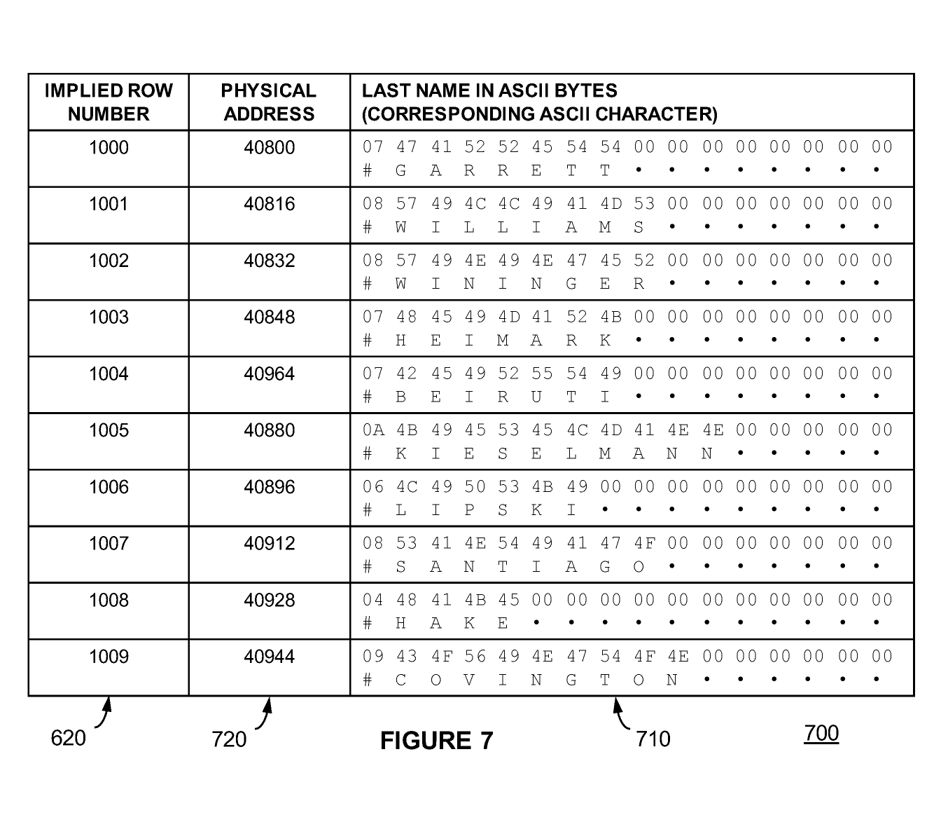

FIG. 7 illustrates original field file 610 as it may be stored in a block 710 of memory 700 according to various implementations of the invention. In such implementations, original field file 610 may be stored in memory 700 as a block 710 of fixed length ASCII character strings (in this example, 16 characters long or wide). As illustrated in FIG. 7, each ASCII character string is padded with zeroes, blanks, nulls, or other padding characters to account for a difference between a length of the data field and a number of characters in the character string as would be appreciated. FIG. 7 also illustrates an implied row number 620, its relationship to individual ASCII character strings of original field file 610 and its physical address 720 defining a location of the ASCII character string in memory 700 as would be appreciated. As illustrated, physical address 720 differs between adjacent rows in increments of 16 bytes corresponding to the number of characters in the fixed length character string as would be appreciated.

According to various implementations of the invention, an array of sorted indices (or sorted row numbers) is generated by determining a sort order for original field file 610 via a second file that initially comprises row numbers 620 (implied or otherwise). The row numbers in this second file point to character strings in original field file 610. According to various implementations of the invention, these character strings are treated as integers and the sort order is determined based on the values of these integers. This sort order is applied to the second file, thereby rearranging the row numbers of the second file and generating an array of sorted row numbers (sometimes referred to generically as an array of sorted indices) while leaving original field file 610 as is. The sorted row numbers (as indices) indirectly impute the sort order onto original field file 610 as would be appreciated. In other words, rather than sorting original field file 610 by its data values, the sort order is applied to pointers pointing to such data values to provide the proper sort order of the data values.

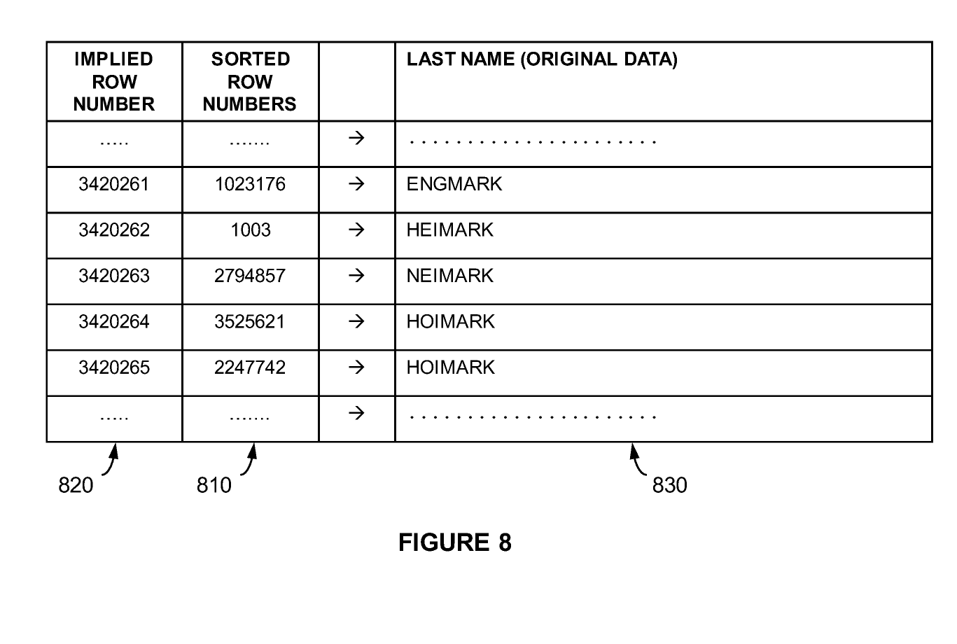

FIG. 8 illustrates sorted row numbers 810, implied row numbers 820 for such sorted row numbers 810, and underlying data values 830 from original field file 610 to which such sorted row numbers 810 point. According to various implementations of the invention, the sort order is a numeric sort order of the numeric or integer values of the ASCII character strings, with each character string treated as a single numeric value as described above. In other words, in the example illustrated in FIG. 8, the 16-character ASCII character string is treated as a single 16-byte integer (which may be referred to by different integer data types depending on the underlying processor as also described above). To be clear, the sort order may or may not correspond to an actual alphabetic sort order of a set of ASCII character strings, though such a sort order could be imposed. In some implementations of the invention, this may be due to the order in which the underlying processor stores (or more appropriately reads/writes) bytes of data into physical memory, e.g., little endian, big endian, etc. Hence, as illustrated in FIG. 8, the sort order of original field file 610 is based on characters occurring in the ASCII character string from right-to-left (rather than as left-to-right as one might expect) due to the fact that the underlying processor in the example (i.e., an Intel processor) stores data in little endian order.

As also illustrated in FIG. 8, a row number of ‘1003’ in sorted row numbers 810 corresponds to a character string “HEIMARK” in original field file 610. This character string falls between character strings “ENGMARK” and “NEIMARK” in underlying data values 830 as specified by row numbers of ‘1023176’ and ‘2794857’ in sorted row numbers 810. As illustrated in FIG. 7, the row number of ‘1003’ is the implied row number 620 pointing to the character string “HEIMARK” of original field file 610 in block 710 of memory 700.

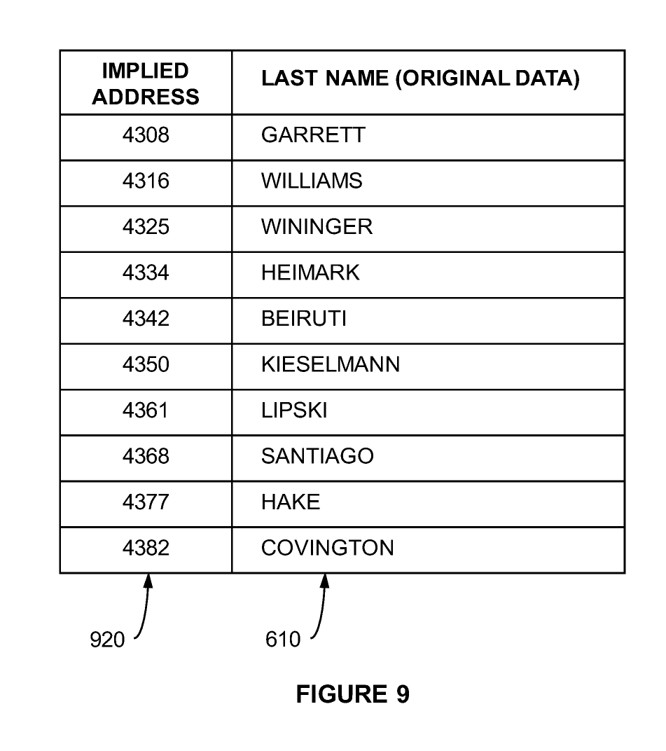

FIG. 9 illustrates an original field file 610 and an implied address 920 in accordance with various other implementations of the invention. In these implementations, original field file 610 corresponds to a last name field stored as contiguous ASCII character strings separated by a byte corresponding to either a character count or a null character as would be appreciated. The character count corresponds to the actual number of characters (absent padding) in a given ASCII character string, often included as a first byte of the character string as would be appreciated. The null character, often included as a last byte of the character string, serves to signify an end of the character string as would be appreciated. Implied addresses 920 corresponds to a physical address, or offset from a physical address, in memory 700 for the beginning of each character string.

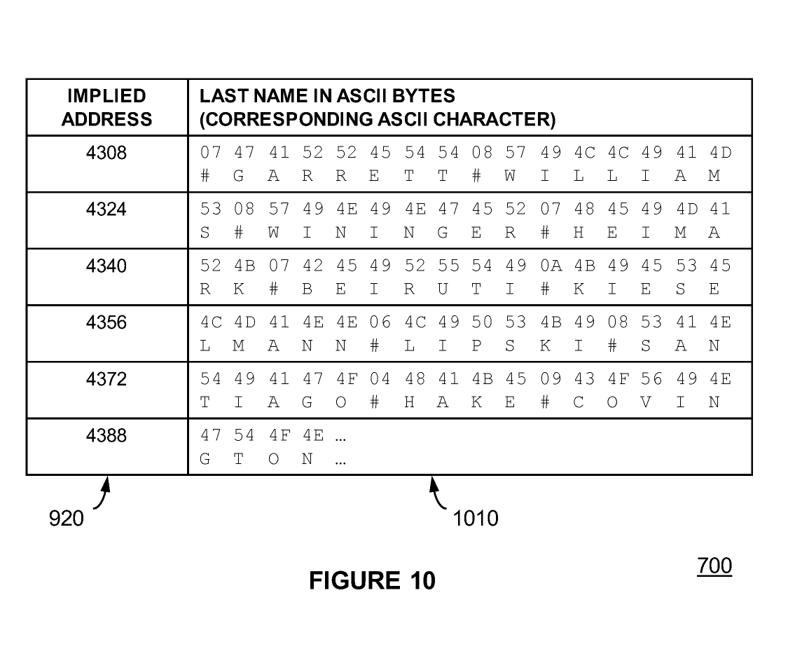

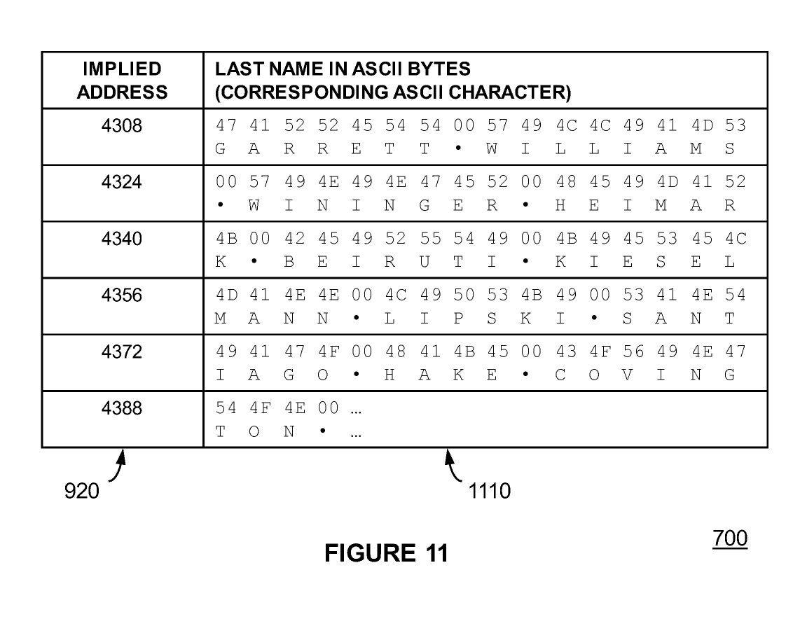

FIG. 10 illustrates original field file 610 as it may be stored in a block 1010 of memory 700 according to implementations of FIG. 9 that use a character count to separate ASCII character strings. FIG. 11 illustrates original field file 610 as it may be stored in a block 1110 of memory 700 according to implementations of FIG. 9 that use a null character to separate ASCII character strings. These implementations of the invention reduce memory requirements by eliminating unnecessary padding utilized by fixed length character strings except for the single byte required for either the character count or the null character. For example, the implementations illustrated in FIG. 7 for fixed length strings requires 160 bytes of memory, whereas the implementations illustrated in FIG. 10 and FIG. 11 each require only 84 bytes of memory. Depending on the fixed field lengths and underlying data, the implementations illustrated in FIG. 10 and FIG. 11 may achieve significant reduction in memory requirements over that of FIG. 7.

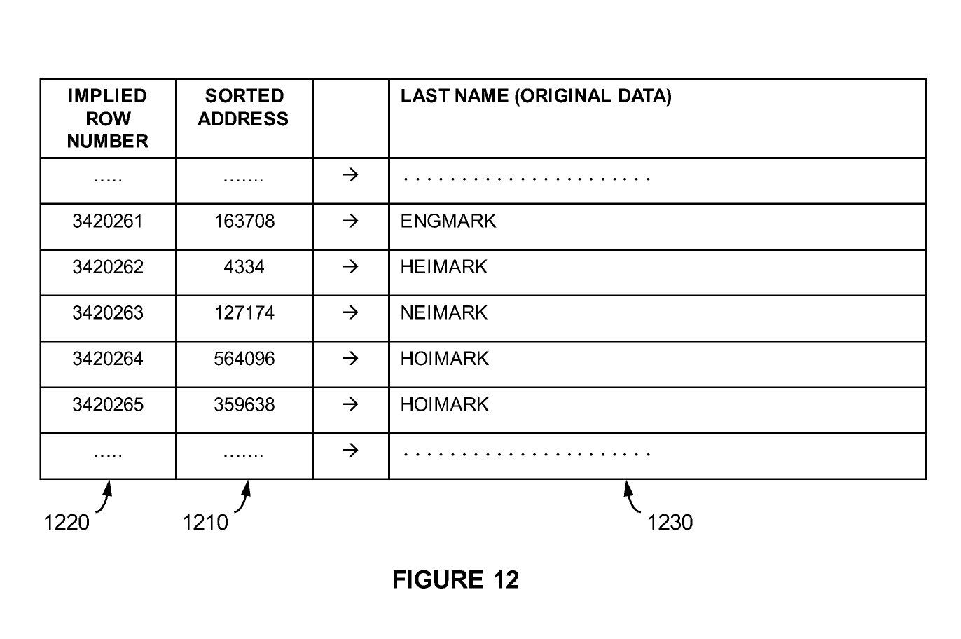

Original field files 610 illustrated in FIG. 10 and FIG. 11 may also be sorted by treating the ASCII character strings as a single numeric value as illustrated in FIG. 12. FIG. 12 illustrates an array of sorted addresses 1210 (also sometimes referred to generically as an array of sorted indices 1210), implied row numbers 1220 for such sorted addresses 1210, and underlying data 1230 from original field file 610 to which such sorted addresses 1210 point in accordance with various implementations of the invention. Again, according to various implementations of the invention, the array of sorted addresses 1210 may be generated by determining a sort order for original field file 610 and determining the corresponding array of sorted addresses 1210 as discussed above. In these implementations, each of sorted addresses 1210 corresponds to a physical address, or offset from a physical address, to the underlying ASCII character string in original field file 610.

As also illustrated in FIG. 12, an address of ‘4334’ in sorted addresses 1210 corresponds to a character string “HEIMARK” in original field file 610. This character string falls between character strings “ENGMARK” and “NEIMARK” in underlying data values 1230 as specified by sorted addresses of ‘163708’ and ‘127174’ in sorted addresses numbers 1210. As illustrated in FIG. 11, the address ‘4334’ is 10 bytes past the implied address ‘4324’ (i.e., 4324+10=4334) and the address ‘4334’ points to the beginning of character string “HEIMARK” of original field file 610 in block 1110 of memory 700.

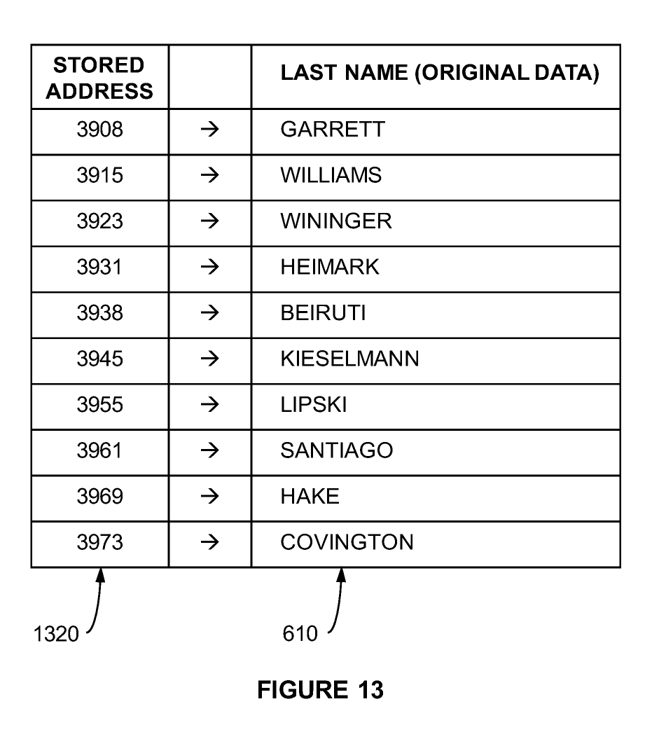

FIG. 13 illustrates original field file 610 and a stored address file 1320 in accordance with various implementations of the invention. In these implementations, original field file 610 corresponds to a last name field stored as contiguous ASCII character strings without separation (i.e., no character count or null character). In these implementations, stored addresses in stored address file 1320 correspond to a physical address (or offset from a physical address) that points to each ASCII character string in original field file 610 so that each ASCII character string may identified as would be appreciated.

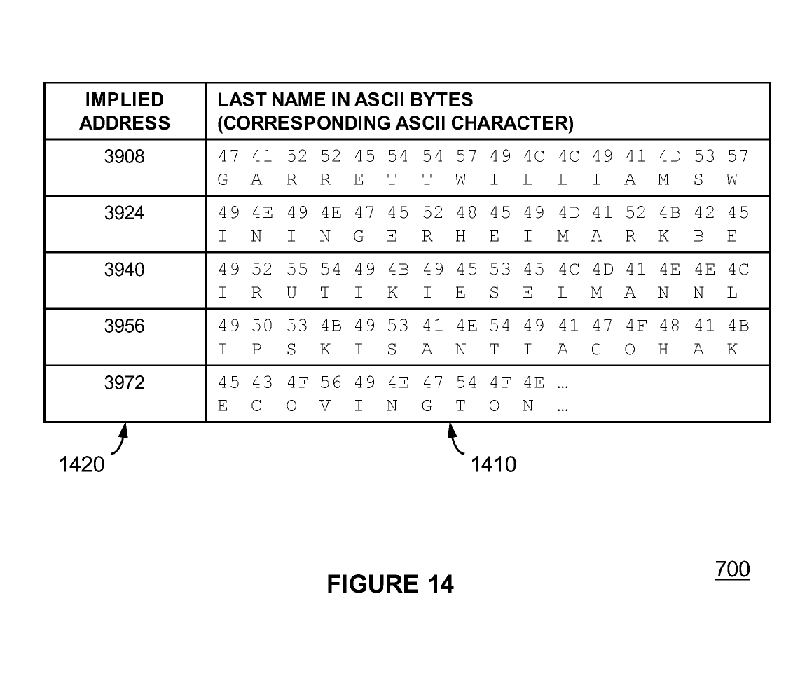

FIG. 14 illustrates original field file 610 as it may be stored in a block 1410 of memory 700 according to various implementations of the invention that contiguously store character strings. As illustrated, original field file 610 may be stored as contiguous ASCII character strings without separation (i.e., no character count or null character) in block 1410. Implied addresses 1420 correspond to a physical address (or offset from a physical address) for each 16-byte portion of block 1410.

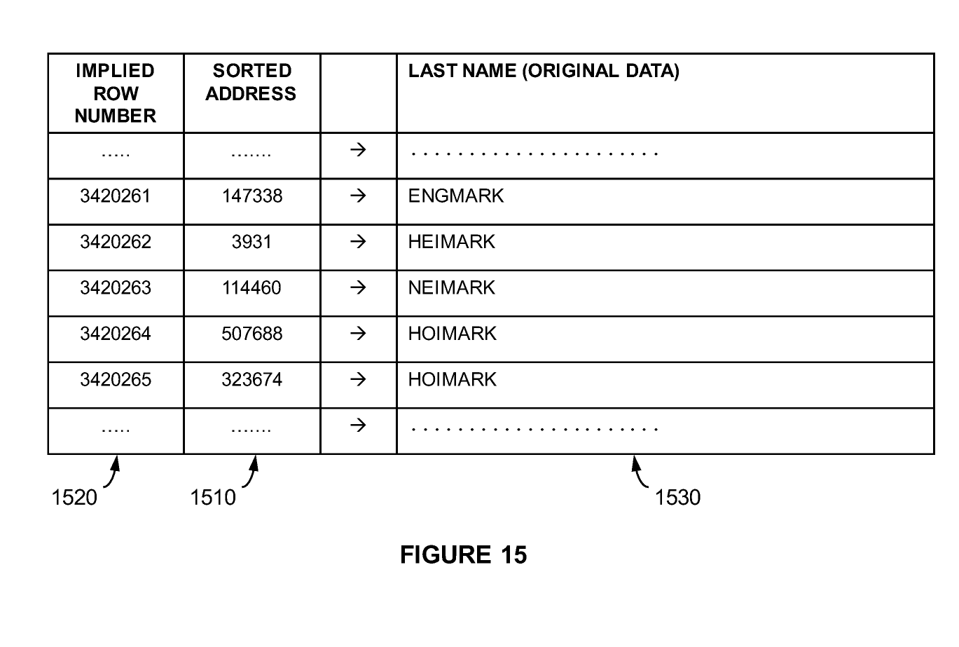

FIG. 15 illustrates an array of sorted addresses 1510, implied row numbers 1520 for such sorted addresses 1510, and underlying data 1530 from original field file 610 to which such sorted addresses 1510 point in accordance with various implementations of the invention. Again, according to various implementations of the invention, the array of sorted addresses 1510 may be generated by determining a sort order for original field file 610 and determining the corresponding array of sorted addresses 1510 as discussed above. In these implementations, each of sorted addresses 1510 corresponds to a physical address, or offset from a physical address, to the underlying ASCII character string in original field file 610.

As also illustrated in FIG. 15, an address of ‘3931’ in sorted addresses 1510 corresponds to a character string “HEIMARK” in original field file 610. This character string falls between character strings “ENGMARK” and “NEIMARK” in underlying data values 1530 as specified by sorted addresses of ‘147338’ and ‘114460’ in sorted addresses numbers 1510. As illustrated in FIG. 13, the address ‘3931’ of stored addresses 1320 points to the beginning of character string “HEIMARK” of original field file 610 in memory 700. As illustrated in FIG. 14, the address ‘3931’ is 7 bytes past the address ‘3924’ of implied addresses 1420 (i.e., 3924+7=3931) and the address ‘3931’ points to the beginning of character string “HEIMARK” of original field file 610 in block 1410 of memory 700.

The implementations of the invention of FIG. 13 reduce memory requirements by eliminating all unnecessary padding utilized by fixed length character strings as well as the extra byte required for the count or null character. For example, the implementations illustrated in FIG. 7, FIG. 10 and FIG. 11 require 160 bytes, 84 bytes, and 84 bytes of memory, respectively, whereas the implementations illustrated in FIG. 13 only require 74 bytes of memory. Thus, the implementation of the invention of FIG. 13 offers a further reduction in memory requirements. This comes with an expense of having to calculate a length of the character string based on a difference between consecutive ones of stored addresses 1320. Such consecutive stored addresses 1320 define a start of one character string and a start of a next one of the character strings in original field file 610 and the difference between these stored addresses 1320 corresponds to a length of the one character string as would be appreciated.

Storing data as data tables 410 in conventional files on a storage device (e.g., disc) and moving such data to RAM each time for processing is extremely time consuming, particularly considering the sizes of today's databases, and further subjects the data to corruption. In addition, these conventional mechanisms require significant hardware resources and software overhead to process the data and even more to protect it. Often, such conventional mechanisms require normalization and/or cumbersome conventional index tables with keys and foreign keys (not to be confused with the arrays of indices of various implementations of the invention). As would be appreciated, the installations supporting such databases consume valuable real estate and electrical power.

Various implementations of the invention solve these and other problems associated with conventional databases. According to various implementations of the invention, original field file 610 and an array of sorted indices are stored for each of data fields 430 (e.g., columns) of data table 410 and these become the basic units of data table 410 on which various processing occurs. Depending on which implementation of the invention is used to store the character strings of original field file 610 in memory 700, the array of sorted indices comprises either sorted rows 810, sorted addresses 1210, or sorted addresses 1510.

As described above, original field file 610 is itself not sorted; rather the array of sorted indices is sorted based on the data values in original field file 610. This allows the integrity of the data values in original field file 610 to be maintained. However, in some implementations of the invention, a copy of original field file 610 may be made and this copy sorted to generate a sorted field file (not otherwise illustrated). In such implementations of the invention, original field file 610, sorted field file, and the array of sorted indices may be stored for each of data fields 430 of data table 410 and these become the basic units of data table 410 on which various processing occurs.

More particularly, a search term may be located in original field files 610 by using a binary search of original field files 610 via the appropriate array of sorted indices. A binary search operates by locating a data value at a middle data entry of a sorted file, determining whether that data value is less than or greater than the search term, and then bisecting either the lower or upper half of the sorted file until the search term is located or no further bisecting of the sorted file is possible. In various implementations of the invention, a binary search is configured to bisect the array of sorted indices, retrieve the underlying data from original field file 610 to which the index at the bisected location points, and compare the underlying data to the search term to determine whether the search term is located or if not, which remaining portion of the array of sorted indices to further bisect. Binary searches are well understood and provide an extremely efficient mechanism for locating search terms in an array of sorted data. This coupled with treating character strings as single integer values greatly enhances the speed of a search of even the largest of databases. For example, for an original field file comprising 4.3 billion data entries (i.e., rows), a maximum number of 32 jumps (i.e., iterations) of a binary search are required to determine whether or not the search term exists in the original field file and for an original field file comprising 18 million trillion data entries, a maximum number of 64 jumps are required. In accordance with various implementations of the invention, modern processors may accomplish such binary searches in less than 25 ns and 50 ns, respectively.

According to various implementations of the invention, original field files 610 and arrays of sorted indices are stored on disks, and in some implementations, without use of conventional file systems (i.e., operating system file systems). Instead, various implementations of the invention address disks directly by reading and/or writing sectors of the disk (e.g., 512 bytes) as would be appreciated. Doing so prevents, among other things, disk fragmentation and data deterioration.

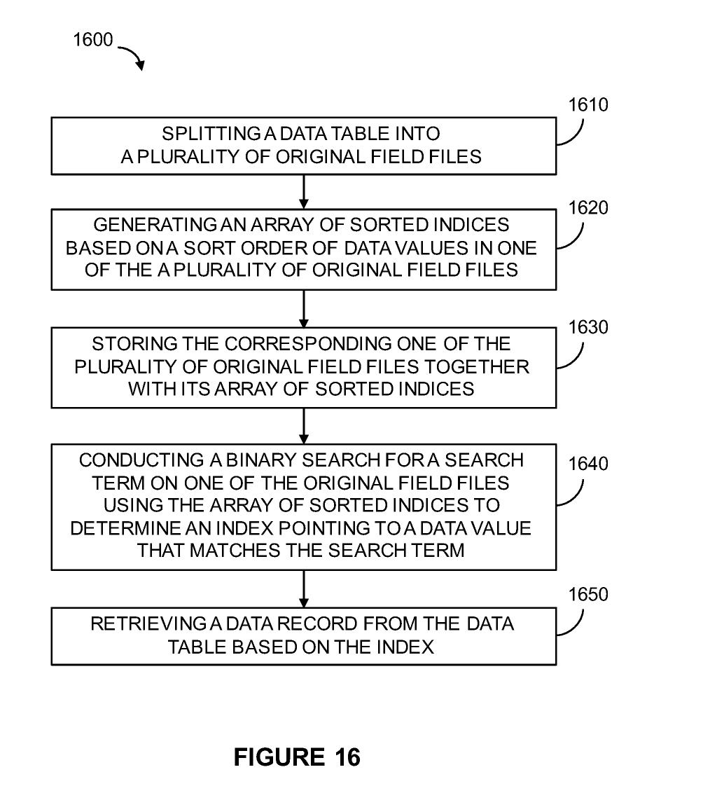

FIG. 16 illustrates an operation 1600 of various implementations of the invention. In an operation 1610, data table 410 is split into a plurality of original field files 610. In an operation 1620, an array of sorted indices is generated based on a sort order of data values in one of original field files 610 as described above. This may be repeated for each of original field files 610 from data table 410. In an operation 1630, each of original field files 610 is stored together with its array of sorted indices. In an operation 1640, a binary search for a search term is conducted against any one or all of original field files 610 using its associated array of sorted indices to determine an index that points to a data value in original field file 610 that matches the search term. In an operation 1650, all or part of data record 420 may be retrieved from data table 410 based on the determined index, where the data record 420 includes a data field 430 having a data value that matches the search term.

While various implementations of the invention are described using the example of an eight character ASCII string for a 64-bit data register, the invention applies to strings of other lengths and data registers of other sizes. In order to accommodate ASCII strings smaller than a given data register, some implementations of the invention may use padding (e.g., space padding on the string or zero or null padding on the integer) as would be appreciated. As would appreciated, such padding may be accomplished through programming or automatically, through use of modern processor op codes. In order to accommodate larger ASCII strings, some implementations of the invention may use larger integer data types (e.g., double word or double integer, quad word or quad integer, etc.) as would be appreciated; doing so will still result in each unique ASCII string having a unique integer value. Further, while various implementations of the invention are described using the example of ASCII characters, the invention applies to other types of character codes such as but not limited to, ANSI, Unicode, UTF-8, UTF-16, UTF-32, Kanji, or other character codes or symbol codes as would be appreciated. Further, while various implementations of the invention are described in reference to character strings representing content, the invention applies to other types of character strings representing, for example, encrypted data, where the underlying encoding scheme may be time variable.

While the invention has been described herein in terms of various implementations, it is not so limited and is limited only by the scope of the following claims, as would be apparent to one skilled in the art. These and other implementations of the invention will become apparent upon consideration of the disclosure provided above. In addition, various components and features described with respect to one implementation of the invention may be used in other implementations as well.

What is claimed is:

1. A method for storing data comprising:
reading a plurality of ASCII characters directly into a single register or storage unit of a computing processor, the plurality of ASCII characters comprising a character string, the character string corresponding to content;
treating the plurality of ASCII characters in the single register as a single value having an integer data type; and
processing the single value as an integer in order to process the content.

2. A method for storing data comprising:
splitting a data table into a plurality of original field files, wherein the data table comprises of a plurality of rows and a plurality of columns, wherein each of the plurality of rows comprises a data record of the data table, wherein each of the plurality of columns comprises a data field of the data table, wherein each of the plurality of original field files comprises a column split from of the plurality of columns, wherein each of the plurality of original field files comprises a number of data values corresponding to a number of the plurality of rows; and
for each of the plurality of original field files:
determining a sort order for the data values in a corresponding one of the plurality of original field files,
generating an array of sorted indices for the corresponding one of the plurality of original field files by sorting an array of indices based on the sort order, wherein each index in the array of indices points to a data value in the corresponding one of the plurality of original field files, and
storing the corresponding one of the plurality of original field files together with the array of sorted indices.

3. The method of claim 2, further comprising:
conducting a binary search for a search term against one of the plurality of original field files using the associated array of sorted indices to determine which index points to a data value in the one of the plurality of original field files that matches the search term; and
retrieving one of the plurality of rows of the data table based on the index.

4. The method of claim 3, wherein one of the plurality of original field files comprises a plurality of character strings, and further comprising:
treating the search term as an integer value; and
reading the data value to which the index points as an integer value, wherein the data value comprises a character string.

5. The method of claim 2, wherein one of the plurality of original field files comprises a plurality of character strings.

6. The method of claim 5, wherein storing the corresponding one of the plurality of original field files together with the array of sorted indices comprises:
storing each of the plurality of character strings as a fixed length character string.

7. The method of claim 5, wherein storing the corresponding one of the plurality of original field files together with the array of sorted indices comprises:
contiguously storing each of the plurality of character strings as a variable length character string together with a character count.

8. The method of claim 5, wherein storing the corresponding one of the plurality of original field files together with the array of sorted indices comprises:
contiguously storing each of the plurality of character strings as a variable length character string together with a null character.

9. The method of claim 5, wherein storing the corresponding one of the plurality of original field files together with the array of sorted indices comprises:
contiguously storing each of the plurality of character strings as a variable length character string; and
storing an address for each of the plurality of character strings.

10. The method of claim 2, further comprising:
sorting the corresponding one of the plurality of original field files to generated a sorted field file, and wherein storing the corresponding one of the plurality of original field files together with its array of sorted indices comprises storing the corresponding one of the plurality of original field files together with its array of sorted indices and its sorted field file.
